(19) United States
(12) Patent Application Publication
(10) Pub. No.: US 2023/0409670 A1
(43) Pub. Date: Dec. 21, 2023

(54) METHOD AND SYSTEM FOR ANALYZING DRIVING RELATIONSHIP BETWEEN ECOSYSTEM SERVICE AND URBAN AGGLOMERATION DEVELOPMENT

(71) Applicant: Nanjing Institute of Environmental Sciences,MEE, Nanjing (CN)

(72) Inventors: Weibo MA, Nanjing (CN); Haidong LI, Nanjing (CN); Lijun ZHAO, Nanjing (CN); Nan WANG, Nanjing (CN); Shaogang LEI, Nanjing (CN); Chenwei LIU, Nanjing (CN); Longjiang ZHANG, Nanjing (CN)

(73) Assignee: Nanjing Institute of Environmental Sciences,MEE, Nanjing (CN)

(21) Appl. No.: 18/203,661

(22) Filed: May 31, 2023

(30) Foreign Application Priority Data
Jun. 8, 2022 (CN) 202210637687.4

(51) Int. Cl. G06F 17/18

(52) U.S. Cl. CPC G06F 17/18

(57) ABSTRACT

A method and a system to analyze the driving relationship between ecosystem service and urban agglomeration development are provided. The spatial-temporal evolution characteristics of ESV in the Yangtze River Delta urban agglomeration are analyzed based on the revised equivalent value coefficient and land use data, the driving characteristics and the driving influence evolution characteristics of 10 indicators of human activities and natural conditions on ESV are explored through RF and SEM, an interaction relationship among influencing factors of ESV and the direct and indirect driving effect of the influencing factors on ESV are quantitatively measured under a unified framework, and the ESV evolution mode and the driving mechanism of the urban agglomeration are explored. The method can deeply study the interaction relationship among the influencing factors of the ESV, as well as the driving characteristics and driving paths of the driving factors to the ESV.

### CROSS REFERENCE TO THE RELATED APPLICATIONS

This application is based upon and claims priority to Chinese Patent Application No. 202210637687.4, filed on Jun. 8, 2022, the entire contents of which are incorporated herein by reference.

### TECHNICAL FIELD

The present invention relates to the technical field of city construction and eco-environmental conservation, and in particular to a method and a system to analyze the driving relationship between ecosystem service and urban agglomeration development.

### BACKGROUND

Ecosystem services represent the benefits that humans obtain from ecosystems, and directly or indirectly promote human well-being through their ecological characteristics, functions, processes, and products. A city is a social-economic-natural composite ecosystem. The supply and demand of urban ecological services are seriously unbalanced due to rapid industrialization and economic expansion, the understanding of the urban ecosystem services can be promoted by analyzing ecosystem service value (ESV) and analyzing ESV spatial characteristics, and there is a complex relationship between the urbanization and the ecosystem services, so that exploring the ESV driving effect of the urban agglomeration is necessary for better understanding the spatial mode, process and mechanism of the urban ecological environment problem, and has important reference significance for improving urban agglomeration-scale ecological well-being and the human living environment health.

In the aspect of studying driving method, the Pearson correlation coefficient can determine the correlation among variables, but cannot indicate the definite causal direction among the variables; Chinese Patent Application No. CN114037351A discloses an ecosystem service value evaluation model, an establishment method and an application, which quantizes the ecosystem service value of an urban ecological space, but does not analyze the spatial-temporal evolution characteristic of a study area; and Chinese Patent Application No. CN108346108A discloses an ecosystem service evolution analysis method and device for an ecotone, which only studies the evolution rule of the ecotone, but does not analyze the driving relationship. It can be seen that the conventional regression analysis method cannot clarify the interaction relationship between variables, consequently, the importance of each variable to the explained variable cannot be measured accurately. Therefore, although the study in the prior art has a wide range, the interaction relationship between the influencing factors of ESV cannot be clarified, and the direct and indirect effects of the influencing factors on ESV are not quantitatively measured in a unified framework. Therefore, how to further analyze the spatial-temporal evolution characteristics, as well as driving characteristics and driving paths of urban agglomeration ecosystem service is an urgent problem to be solved for those skilled in the art.

### SUMMARY

In view of this, the present invention discloses a method and system for analyzing the driving relationship between ecosystem service and urban agglomeration development, so as to solve the problems in the background section.

In order to achieve the above objective, the present invention adopts the following technical solution: a method for analyzing the driving relationship between ecosystem service and urban agglomeration development, comprising the following specific steps:
collecting data comprising ESV accounting data and ESV driving data;
calculating an ecosystem service value by using an equivalent factor method, and revising an equivalent value coefficient through the ESV accounting data;
analyzing spatial-temporal evolution characteristics of the ecosystem service value based on the revised equivalent value coefficient and land use data;
analyzing a driving influence of the ESV driving data on the ecosystem service value by using a random forest; and
analyzing a driving path of the ESV driving data to the ecosystem service value by using a structural equation model.

Optionally, the ESV driving data comprises human activity data and natural condition data; wherein the human activity data comprises population density, night light index, land use structure, and PM_{2.5} concentration, and the natural condition data comprises elevation, grade, normalized difference vegetation index, precipitation, temperature, and drainage density.

Optionally, a calculation process of the ecosystem service value is as follows:

ESV=Σⱼ₌₁ⁿΣᵢ₌₁ⁿAᵢ×E_{i,j}×Eⱼ;

wherein ESV is ecosystem services value, E_{i,j}, represents the j^{th} ecosystem service value coefficient of the i^{th} ecosystem type, Aᵢ is an area of the i^{th} type of ecosystem, and E; is ecosystem service equivalent of the j^{th} type of ecosystem after regional correction, Eⱼ=λ·Eₒⱼ; and λ is a region correction coefficient of the ecosystem service equivalent, and Eₒⱼ is the national average ecosystem service equivalent of the j^{th} type of ecosystem.

Optionally, in the random forest, the importance of a variable is estimated by an out-of-bag error sample with the following formula:

$$IMp ( {var}_{i} ) = \frac{{\sum }_{j = 1}^{n} ( e r r O O B {2}_{i , j} - e r r O O B {1}_{i , j} )}{n} ;$$

wherein IMp(varᵢ) is the importance of variable i, errOOB1_{i,j} is an error calculated according to out-of-bag data of the variable i in CARTⱼ, errOOB2_{i,j} is an error calculated according to the out-of-bag data of the variable i in CARTⱼ plus noise interference, and n is the number of CART.

Optionally, the structural equation model is a piecewise structural equation model, the driving path of the ESV driving data is normalized by linear fitting a grouping model, and then the explanation degree of the overall fit of the piecewise structural equation model is evaluated by using Shipley's test of separation.

Optionally, the method further comprises: quantitatively measuring an interaction relationship among influencing factors of the ecosystem service value and the direct or indirect driving effect thereof on the ecosystem service value through a structural equation model.

In another aspect, provided is a system for analyzing the driving relationship between ecosystem service and urban agglomeration development, which comprises: a data collection module, an ESV accounting and coefficient revising module, an ESV evolution analysis module, a driving factor analysis module, and a driving path analysis module; wherein
the data collection module is configured to collect data comprising ESV accounting data and ESV driving data;
the ESV accounting and coefficient revising module is configured to calculate an ecosystem service value by using an equivalent factor method, and revise an equivalent value coefficient through the ESV accounting data;
the ESV evolution analysis module is configured to analyze spatial-temporal evolution characteristics of the ecosystem service value based on the revised equivalent value coefficient and land use data;
the driving factor analysis module is configured to analyze a driving influence of the ESV driving data on the ecosystem service value by using a random forest; and
the driving path analysis module is configured to analyze a driving path of the ESV driving data to the ecosystem service value by using a structural equation model.

Optionally, the spatial-temporal evolution characteristics comprise spatial-temporal variation, spatial heterogeneity variation, and analysis of cold and hot spots.

It can be seen from the above technical solutions, compared with the prior art, the present invention discloses and provides a method and system for analyzing the driving relationship between ecosystem service and urban agglomeration development, which has the following beneficial technical effects: the spatial-temporal evolution characteristics of ESV in the urban agglomeration are analyzed based on the revised equivalent value coefficient and land use data, the driving characteristics and the driving influence evolution characteristics of 10 indicators of human activities and natural conditions on ESV are explored through RF and SEM, an interaction relationship among influencing factors of ESV and the direct and indirect driving effect of the influencing factors on ESV are quantitatively measured under a unified framework, and the ESV evolution mode and the driving mechanism of the urban agglomeration are explored. Through analysis of the ecosystem service value, the coordinated governance of urban ecological protection can be enhanced from the aspect of systematic integrity according to a causal driving effect.

### BRIEF DESCRIPTION OF THE DRAWINGS

In order to more clearly illustrate the technical solutions in the embodiments of the present invention or in the prior art, the drawings required to be used in the description of the embodiments or the prior art are briefly introduced below. It is obvious that the drawings in the description below are merely embodiments of the present invention, and those of ordinary skill in the art can obtain other drawings according to the drawings provided without creative efforts.

FIG. 1 is a flow chart of a method according to the present invention;

FIG. 2 is a diagram showing a correlation between ESV in the Yangtze River Delta urban agglomeration and driving factors from 2000 to 2020 according to the present invention;

FIG. 3A is a diagram of the structural equation modeling of ESV in the Yangtze River Delta urban agglomeration in 2000 according to the present invention;

FIG. 3B is a diagram of the structural equation modeling of ESV in the Yangtze River Delta urban agglomeration in 2010 according to the present invention;

FIG. 3C is a diagram of the structural equation modeling of ESV in the Yangtze River Delta urban agglomeration in 2020 according to the present invention;

FIG. 3D is a diagram of the structural equation modeling of ESV in the Yangtze River Delta urban agglomeration from 2000 to 2020 according to the present invention; and

FIG. 4 is a diagram of a structure of a system according to the present invention.

### DETAILED DESCRIPTION OF THE EMBODIMENTS

The following clearly and completely describes the technical solutions in embodiments of the present invention with reference to the accompanying drawings in embodiments of the present invention. It is clear that the described embodiments are merely a part rather than all of embodiments of the present invention. Based on the embodiments of the present invention, all other embodiments obtained by those of ordinary skill in the art without creative efforts shall fall within the protection scope of the present invention.

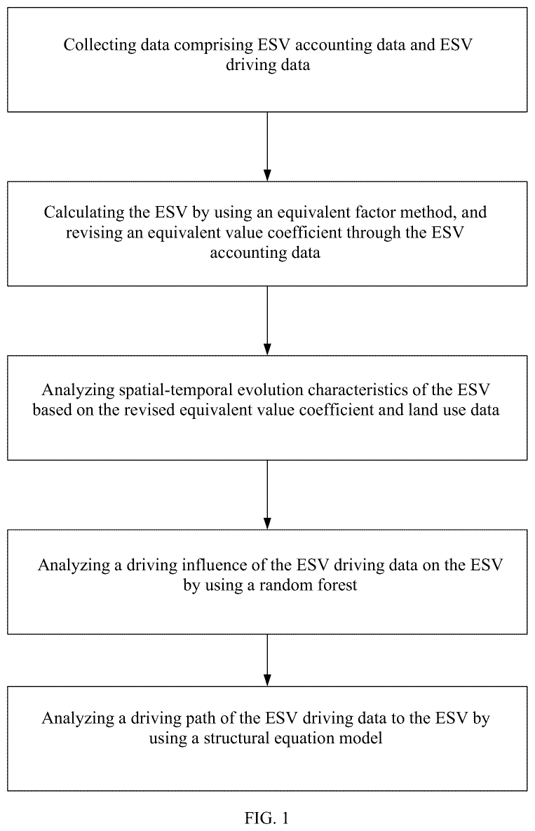

An embodiment of the present invention discloses a method for analyzing the driving relationship between ecosystem service and urban agglomeration development, as shown in FIG. 1, which comprises the following specific steps:
S1: collecting data comprising ESV accounting data and ESV driving data;
S2: calculating an ecosystem service value by using an equivalent factor method, and revising an equivalent value coefficient through the ESV accounting data;
S3: analyzing spatial-temporal evolution characteristics of the ecosystem service value based on the revised equivalent value coefficient and land use data;
S4: analyzing a driving influence of the ESV driving data on the ecosystem service value by using a random forest; and
S5: analyzing a driving path of the ESV driving data to the ecosystem service value by using a structural equation model.

Specifically, in this embodiment, the Yangtze River Delta urban agglomeration is taken as a study object, and the method of the present invention is used to analyze the spatial-temporal evolution characteristics of ESV in the Yangtze River Delta urban agglomeration, as well as the driving characteristics and driving path evolution characteristics on the ESV.

The Yangtze River Delta urban agglomeration is located in the alluvial plain before the Yangtze River flows into the sea, which includes 27 central cities of Shanghai, Nanjing, Wuxi, Changzhou, Suzhou, Nantong, Yancheng, Yangzhou, Zhenjiang, and Taizhou in Jiangsu Province, Hangzhou, Ningbo, Wenzhou, Jiaxing, Huzhou, Shaoxing, Jinhua, Zhoushan, and Taizhou in Zhejiang Province, Hefei, Wuhu, Ma'anshan, Tongling, Anqing, Chuzhou, Chizhou, and Xuancheng in Anhui Province according to the Outline of the Integrated Regional Development Of the Yangtze River Delta and the Yangtze River Delta City Cluster Development Plan.

In this embodiment, the specific implementation process of step S1 is described as follows:

ESV Accounting Data:

An equivalent factor method is selected to perform ESV accounting, and land use, social economy, crop yield, ecological indicators and the like in the Yangtze River Delta region are taken as the basis for revising model parameters. The ecological service value coefficient of the Yangtze River Delta region is corrected by using net primary productivity (NPP) product data (MOD17A3H) and precipitation product data (https://crudata.uea.ac.uk/cru/data/hrg/cru_ts_4.04/). Grain yield, seeding area, and the like are mainly sourced from the statistical yearbooks of Shanghai, Jiangsu, Zhejiang, and Anhui Provinces. The land use data of the Yangtze River Delta urban agglomeration (https://www.globallandcover.com) shows that the Yangtze River Delta urban agglomeration had a basic trend of continuous decline in arable land, forest land and wetland, and gradual increase in the water body and artificial surface from 2000 to 2020.

ESV Driving Data:

To reveal the ESV driving effect of the Yangtze River Delta urban agglomeration, 10 specific indicators of 2 aspects of human activities and natural conditions are selected as explanatory variables, as shown in Table 1. The artificial activity driving types comprise population density, night light index, land use structure, and PM_{2.5} concentration, and the natural conditions comprise elevation, grade, normalized difference vegetation index (NDVI), precipitation, temperature, and drainage density. The night light index has an association with the economic development level and has a higher spatial resolution, and the economic development level is represented by the night light index. Meanwhile, the northern region of the Yangtze River Delta urban agglomeration is a typical drainage dense area in eastern China, and the driving effect of drainage density on ESV has been included in the analysis. Air environmental quality has a complex relationship with ESV, with PM_{2.5} being selected as a driving factor. Meanwhile, rapid urbanization leads to drastic changes in land use structures, and ecological lands are important influencing factors for driving evolution of ESV, therefore, typical ecological lands of arable land, forest land and water body for land use have been included in the exploration range. Population density, elevation, grade, precipitation, and surface temperature are all conventional driving factors.

TABLE 1

| | Indicator | | | |
|---|---|---|---|---|
| | characterization/ | | | |
| Type | Unit | Precision | | Data source |
| Human | Population | 1 | km | https://www.worldpop.org/ |
| activity | density/10,000 | | | |
| | people/km² | | | |
| | Night light/ | 1 | km | https://dataverse.harvard.edu/ |
| | nano- | | | dataset.xhtml?persistentId=doi:10.7910/ |
| | Wcm⁻²sr⁻¹ | | | DVN/YGIVCD |
| | Land use | 30 | m | https://www.globallandcover.com |
| | structure (arable | | | |
| | land, forest land | | | |
| | and water | | | |
| | body)/m² | | | |
| | Drainage | 1 | km | https://www.openstreetmap.org |
| | density/km/km² | | | |
| | PM_{2.5} | 1 | km | https://modis.gsfc.nasa.gov/ |
| | concentration/ | | | data/dataprod/mod13.php |
| | ug/m³ | | | |
| Natural | Elevation/m | 30 | m | http://srtm.csi.cgiar.org/srtmdata/ |
| condition | Grade/° | 30 | m | http://srtm.csi.cgiar.org/srtmdata/ |
| | Normalized | 500 | m | https://modis.gsfc.nasa.gov/ |
| | difference | | | data/dataprod/mod13.php |
| | vegetation index | | | |
| | (NDVI) | | | |
| | Precipitation/mm | 1 | km | http://data.cma.cn/ |
| | Surface | 1 | km | http://data.cma.cn/ |
| | temperature/° C. | | | |

In this embodiment, the specific implementation process of step S2 and step S3 is described as follows:
the ESV of the Yangtze River Delta urban agglomeration is estimated by using an equivalent factor method, and the equivalent factor method is suitable for the ESV accounting of large regional scales. The calculation process is as follows:

ESV=Σⱼ₌₁ⁿΣᵢ₌₁ⁿAᵢ×E_{i,j}×Eⱼ;

wherein ESV is ecosystem services value, E_{i,j} represents the j^{th} ecosystem service value coefficient of the i^{th} ecosystem type, Aᵢ is an area of the i^{th} type of ecosystem, and E represents the economic value of grain yield per unit area. Meanwhile, the value coefficient is revised through regional crop yield area, NPP, and precipitation. 1/7 revised normalized equivalent factor of the unit price of farmland food production service are output value of a natural ecosystem without human investment, and the formula is as follows:

$$E = \frac{1}{7} \times \frac{T}{X}$$

wherein E represents the economic value of grain yield per unit area, T represents the total value of grain in the study area, and X represents the sown area of grain in the study area. Partial value coefficients are further revised through NPP and precipitation data according to a condition factor method. The calculation formulas are as follows:

$$λ = \frac{B}{{B}_{0}}$$

$${E}_{j} = λ• {E}_{oj} ;$$

wherein Eⱼ is ecosystem service equivalent of the j^{th} type of ecosystem after regional correction, λ is a region correction coefficient of the ecosystem service equivalent, B is the pixel-by-pixel NPP of the Yangtze River Delta urban agglomeration, Eⱼ is the ecosystem service equivalent of the j^{th} type of ecosystem after regional correction, E₀ⱼ is the national average ecosystem service equivalent of the j^{th} type of ecosystem, where j=1, 2, . . . , and 8, which are sequentially food production, raw material production, gas regulation, climate regulation, environment purification, nutrient circulation maintenance, biodiversity maintenance, and aesthetic landscape service provision; and based on the revision of the pixel-by-pixel of the 8 ecological service value coefficients by NPP, the service value equivalents of water resource supply and hydrological regulation will continue to be revised through precipitation product data. From 2000 to 2020, the planting area of crops in the Yangtze River Delta region is 1047.24×10⁴ hm², and the corresponding total yield of 3465.93×10⁸ yuan, so that the economic value of grain yield per unit area is 4727.96 yuan/hm². The value equivalents of different land use ecological service functions are obtained through statistics, as shown in Table 2.

TABLE 2

| | | | Mixed | | | | | |
|---|---|---|---|---|---|---|---|---|
| | | | forest of | | | | | |
| | | | evergreen | | | | | |
| | | | conifers | | | | | |
| | | | and | | | | | |
| | | Paddy | deciduous | Shrub | | | Water | |
| Type I | Type II | field | trees | tussock | Shrub | Wetland | body | Barren |
| Supply | Food | 772.91 | 176.18 | 215.96 | 107.98 | 289.84 | 454.66 | 0.00 |
| service | production | | | | | | | |
| | Raw material | 51.15 | 403.51 | 318.26 | 244.38 | 284.16 | 130.71 | 0.00 |
| | production | | | | | | | |
| | Water | −2238.22 | 314.88 | 263.82 | 187.23 | 2204.17 | 7055.06 | 0.00 |
| | resource | | | | | | | |
| | supply | | | | | | | |
| Regulation | Gas | 630.83 | 1335.55 | 1119.59 | 801.33 | 1079.81 | 437.61 | 11.37 |
| service | regulation | | | | | | | |
| | Climate | 323.94 | 3995.29 | 2960.95 | 2403.99 | 2045.95 | 1301.45 | 0.00 |
| | regulation | | | | | | | |
| | Environment | 96.61 | 1130.96 | 977.51 | 727.45 | 2045.95 | 3154.17 | 56.83 |
| | purification | | | | | | | |
| | Hydrological | 2314.81 | 2987.13 | 3250.95 | 2850.96 | 20620.52 | 87009.59 | 25.53 |
| | regulation | | | | | | | |
| Support | Soil | 4.26 | 1216.98 | 1021.24 | 731.89 | 982.94 | 395.73 | 8.51 |
| service | conservation | | | | | | | |
| | Nutrient | 107.98 | 125.03 | 102.30 | 73.88 | 102.30 | 39.78 | 0.00 |
| | circulation | | | | | | | |
| | maintenance | | | | | | | |
| | Biodiversity | 119.35 | 1477.63 | 1238.94 | 892.26 | 4472.68 | 1449.22 | 11.37 |
| | maintenance | | | | | | | |
| Culture | Aesthetic | 51.15 | 647.88 | 545.59 | 392.14 | 2688.15 | 1074.12 | 5.68 |
| service | landscape | | | | | | | |

| | | | | | | | |
|---|---|---|---|---|---|---|---|
| Total | 2234.78 | 13811.01 | 12015.09 | 9413.49 | 36816.48 | 102502.11 | 119.29 |

In the present invention, the ecosystem service value (ESV) driving effect of an urban agglomeration is analyzed through correlation analysis, RF and SEM, the spatial-temporal evolution characteristics of ESV in the urban agglomeration are analyzed based on revised value equivalent coefficient, land use and other data correlation, and the driving characteristics and the driving influence evolution characteristics of 10 indicators of human activities and natural conditions on ESV are explored by using a random forest (RF) and a structural equation model (SEM). Specifically, RF is used to model the explanation degree of the 10 driving factors to the ESV response, and SEM is used to further analyze and model the driving path of the driving factors, so that it is the latest attempt in the art to introduce SEM into ESV driving analysis.

In this embodiment, the specific implementation process of step S4 is described as follows:

RF is an ensemble learning method that is robust to overfitting and can adequately detect the degree to which a variable contributes to an explanatory variable. The essence of training an RF is to train a plurality of classification and regression trees (CART). CART is a binary tree model, and the core of the CART is the selection of cutting variables and cutting points. In RF, a single CART firstly traverses a part of variable and variable data, then determines the optimal cutting variable and cutting point according to the impurity of the node after cutting, and synthesizes the results of all trees to obtain a final model. An RF regression method is used, where the calculation formula of the node impurity is as follows:

$$G ( x , y ) = \frac{1}{{N}_{s}} ( {\sum }_{{y}_{i} ∈ {X}_{left}} {( {y}_{i} - {\overline{y}}_{left} )}^{2} + {\sum }_{{y}_{i} ∈ {X}_{right}} {( {y}_{i} - {\overline{y}}_{r i g h t} )}^{2} )$$

wherein x is a splitting variable, y is a splitting value of x, Nₛ is the number of all training samples, X_{left} is a data set consisting of yᵢ (yᵢ<y), X_{right} is a data set consisting of yᵢ(yᵢ>y), and y̅_{left} and y̅_{right} are the average values of X_{left} and X_{right}, respectively.

Meanwhile, the RF estimates the importance of the variables through out-of-bag error (OOB) samples. The calculation formula is as follows:

$$IMp ( {var}_{i} ) = \frac{{\sum }_{j = 1}^{n} ( errOOB {2}_{i j} - errOOB {1}_{i j} )}{n}$$

wherein IMp(varᵢ) is the importance of variable i, errOOB1_{i,j} is an error calculated according to out-of-bag data of the variable i in CARTⱼ, errOOB2_{i,j} is an error calculated according to the out-of-bag data of the variable i in CARTⱼ plus noise interference, and n is the number of CART. CART is a classification and regression tree, and is a binary tree algorithm. RF is used to model the explanation degree of the 10 driving factors in Table 1 to the ESV response, and the explanation degree % of the variance Var is the explanation ability of the RF model, the maximum is 100%; and the relative importance of a driving factor among driving factors that affects noise to ESV is measured by measurement.

In this embodiment, the specific implementation process of step S5 is described as follows:

An important difference between SEM and regression analysis is that a response variable (also called a dependent variable in regression analysis) in SEM can also be used as a predictor variable (an independent variable) for other response variables. In other words, the SEM contains both direct and indirect causal relationships among a plurality of variables. Compared with conventional variance-covariance based SEM, the piecewise SEM can: 1) combine a plurality of independent linear models into a single causal network; 2) use Shipley's test of separation to check if any paths are missing in the model; and 3) use the Akaike information criterion (AIC) to compare nested models. The piecewise SEM has not incorporated latent or complex variables and is therefore often more accurately referred to as validated path analysis.

By grouping causal relationships, a driving path of 10 indicators of human activities and natural conditions to the ESV in the Yangtze River Delta urban agglomeration is studied by using the piecewise SEM, and meanwhile, the situation that the ESV is indirectly driven by taking the forest land and the NDVI as intermediate paths is also considered. The grouping models are fitted by linear models, the driving paths of the driving factors in Table 1 are normalized, and finally the explanation degree of the overall fitting of the piecewise SEM is evaluated by Shipley's separation test. The piecewise SEM is implemented in the R software package “piecewiseSEM”.

By the above analysis, the spatial-temporal characteristics of the ESV and ESV driving factors of the Yangtze River Delta urban agglomeration can be obtained.

Table 3 shows the ESV variations of the Yangtze River Delta urban agglomeration from 2000 to 2020. It can be found from Table 4 that, from 2000 to 2020, the overall ESV of the Yangtze River Delta urban agglomeration showed a change trend of first decreasing and then increasing, and the ecological service value of food production, raw material production, gas regulation, climate regulation, biodiversity maintenance, nutrient circulation maintenance, and aesthetic landscape types all showed a decreasing trend; however, water resource supply and hydrological regulation showed a trend of decreasing loss or increasing. Specifically, from 2000 to 2010, the value of hydrological regulation services decreased by 120.52×10⁸ yuan, accounting for 54.0500 of the total decrease; while the value of water resource supply services increased by 75.81×10⁸ yuan. From 2010 to 2020, the value of hydrological regulation and water resource supply services increased by 1096.2×10⁸ yuan, which is the main contribution to the overall ESV improvement.

TABLE 3

| | | | | From 2000 to 2010 | | From 2010 to 2020 | | From 2000 to 2020 | |
|---|---|---|---|---|---|---|---|---|---|
| Ecosystem | 2000 | 2010 | 2020 | Variation/× 10⁸ | Amplitude of | Variation/× 10⁸ | Amplitude of | Variation/× 10⁸ | Amplitude of |
| service type | ESV/×10⁸ yuan | | | yuan | variation/% | yuan | variation/% | yuan | variation/% |
| Food | 1137.67 | 1095.22 | 1011.77 | −42.45 | 19.04 | −83.45 | −8.96 | −125.91 | −17.76 |
| production | | | | | | | | | |
| Raw material | 357.96 | 353.68 | 348.16 | −4.28 | 1.92 | −5.53 | −0.59 | −9.80 | −1.38 |
| production | | | | | | | | | |
| Water | −805.99 | −730.19 | −473.51 | 75.81 | −34.00 | 256.68 | 27.55 | 332.49 | 46.91 |
| resource | | | | | | | | | |
| supply | | | | | | | | | |
| Gas regulation | 1747.79 | 1708.56 | 1635.96 | −39.24 | 17.60 | −72.60 | −7.79 | −111.84 | −15.78 |
| Climate | 3301.83 | 3271.44 | 3240.19 | −30.40 | 13.63 | −31.24 | −3.35 | −61.64 | −8.70 |
| regulation | | | | | | | | | |
| Environment | 1463.67 | 1450.67 | 1488.47 | −12.99 | 5.83 | 37.80 | 4.06 | 24.80 | 3.50 |
| purification | | | | | | | | | |
| Hydrological | 13684.63 | 13564.11 | 14403.64 | −120.52 | 54.05 | 839.52 | 90.10 | 719.01 | 101.44 |
| regulation | | | | | | | | | |
| Soil | 1208.48 | 1201.63 | 1202.37 | −6.85 | 3.07 | 0.74 | 0.08 | −6.11 | −0.86 |
| conservation | | | | | | | | | |
| Nutrient | 222.22 | 215.91 | 203.37 | −6.31 | 2.83 | −12.54 | −1.35 | −18.85 | −2.66 |
| circulation | | | | | | | | | |
| maintenance | | | | | | | | | |
| Biodiversity | 1461.41 | 1438.17 | 1435.38 | −23.24 | 10.42 | −2.79 | −0.30 | −26.03 | −3.67 |
| maintenance | | | | | | | | | |
| Aesthetic | 728.86 | 716.37 | 721.56 | −12.49 | 5.60 | 5.19 | 0.56 | −7.30 | −1.03 |
| landscape | | | | | | | | | |
| Total | 24508.53 | 24285.57 | 25217.34 | −222.96 | 100.00 | 931.77 | 100.00 | 708.81 | 100.00 |

From the perspective of spatial variation, the Yangtze River Delta urban agglomeration shows the highest ESV in the key lakes, wetlands, and water system areas, followed by the southern hilly areas, the northern farmland area, and the lowest ESV in the built-up area of the urban agglomeration.

From the perspective of spatial heterogeneity, the Moran's I of the ESV space of the Yangtze River Delta urban agglomeration is greater than 0.45 and the Z-score of ESV is greater than 1.96 at different spatial resolution scales (P-values pass the 1% significance test), which indicates that the ESV of the Yangtze River Delta urban agglomeration has a strong spatial aggregation pattern.

The spatial heterogeneity expression ability and computational workload are integrated, and the 5 km resolution is determined as a spatial unit for ESV-driven analysis. It can be seen that from 2000 to 2010, there are spatial cold spots in the southern Anqing, the northern Chizhou, the areas of Nantong that border Shanghai, the areas of Suzhou that border Wuxi and Shanghai, the areas of Hangzhou that border Huzhou and Jiaxing, and Zhoushan, which indicates that the decrease in ESV in these regions shows a spatial aggregation effect; however, there are spatial hot spots in the southern areas of Changzhou, Wuxi and Suzhou, the border areas of Nanjing, Ma'anshan, Wuhu and Xuancheng, Tongling, Chizhou, Anqing, the northern Taizhou, the border areas of Chuzhou and Hefei, and the coastal areas of Ningbo, Taizhou and Wenzhou, which indicates that the increase in ESV in these regions shows a spatial aggregation effect.

Further, a random forest model is used for analysis, and Table 4 shows that the variance explanation degree of the RF model in 2000, 2010 and 2020 are 91.53%, 91.83% and 89.97%, respectively, which are all over 89%. This indicates that this model can achieve a strong explanation degree of ESV by driving factors.

TABLE 4

| Indicator | 2000 | 2010 | 2020 |
|---|---|---|---|
| Var explanation degree % | 91.53 | 91.83 | 89.97 |
| RMSE/*10¹² | 1.05 | 1.18 | 1.72 |

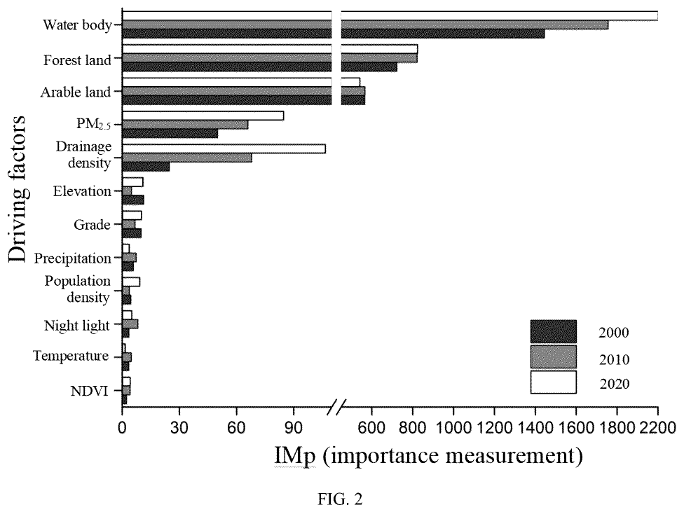

As shown in FIG. 2, water body, forest land, arable land, PM_{2.5}, and drainage density were important driving factors of ESV in the Yangtze River Delta urban agglomeration from 2000 to 2020, the importance of the influencing factor of the water body was much higher than that of other influencing factors, and the average value reached 1781. From 2000 to 2020, the importance of water area, forest land, PM_{2.5}, and drainage density all showed an increasing trend, while the importance of influencing factor of arable land showed a slightly decreasing trend. The importance of the influencing factors such as elevation, grade, precipitation, population density, night light, temperature, and NDVI was low, and there was no obvious change trend feature.

It can be seen from SEM analysis results that P-value tested by Chi-Square and Fisher's C in all years is greater than 0.05, which indicates that the causal relationship hypothesis passes the test, and the structural equation model has a better explanation degree, and reliable precision and reliability. Overall, the explanation degrees of driving factors such as water area, forest land, arable land, drainage density, and PM_{2.5} to ESV in 2000, ESV in 2010, ESV in 2020, and ESV variation from 2000 to 2020 were 85%, 84%, 83%, and 72%, respectively. From 2000 to 2020, the explanation degree of the driving factors to the forest land was 47%-55%, and the explanation degree of the driving degree to the NDVI was 16%-20%.

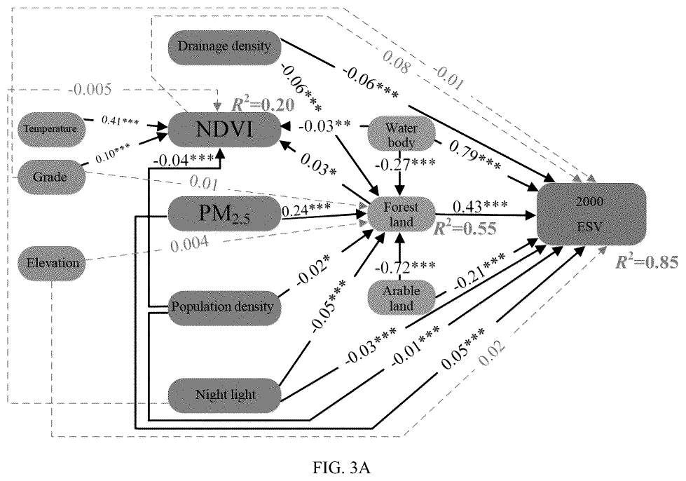

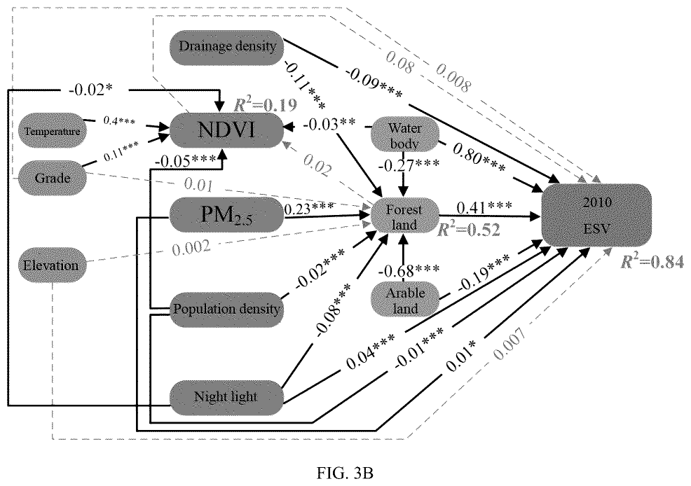

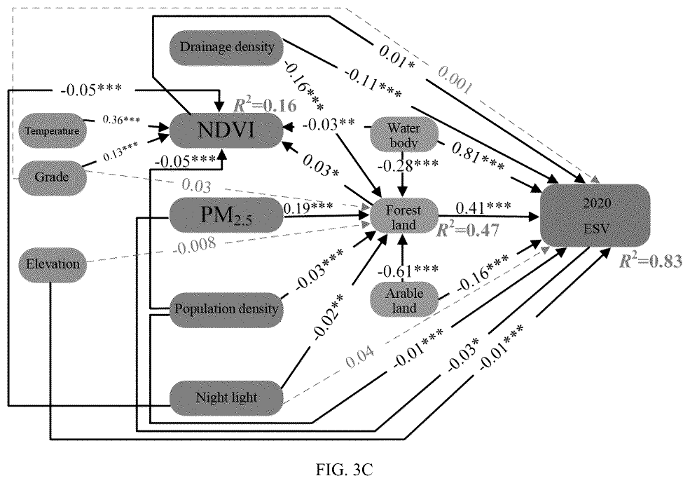

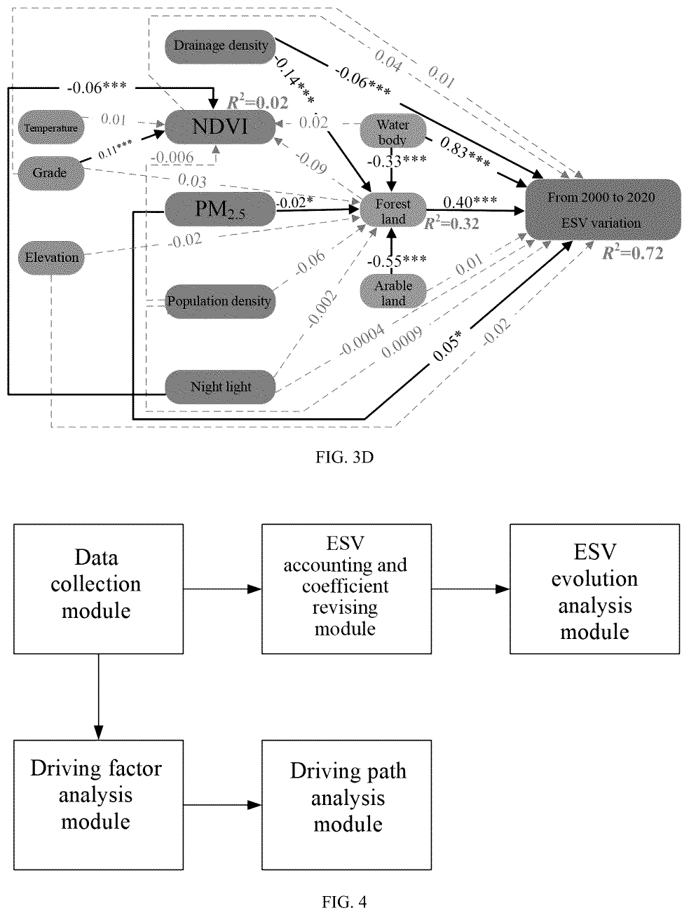

As shown in FIG. 3A to FIG. 3D, in 2000, water body, forest land, and PM_{2.5} had direct positive driving effects on ESV of the Yangtze River Delta urban agglomeration; however, arable land, drainage density, night light, and population density have direct negative driving effects. PM_{2.5} has a significant direct positive driving effect on the forest land, with a normalized path coefficient β of 0.24; arable land, water body, drainage density, night light, population density, and the like all have negative driving effects on forest land, and factors which directly have positive effects on NDVI comprise temperature, grade, and forest land; and population density and water body have negative effects with a normalized path coefficient β of −0.04 and −0.03, respectively. PM_{2.5}, population density, and night light also have indirect effects on ESV through forest land. The driving effect of elevation, temperature, and grade on ESV and forest land of the Yangtze River Delta urban agglomeration is not significant. The difference between the ESV driving models of the Yangtze River Delta urban agglomeration in 2010 and 2020 is small compared with that in 2000.

In another aspect, provided is a system for analyzing the driving relationship between ecosystem service and urban agglomeration development, as shown in FIG. 4, which comprises: a data collection module, an ESV accounting and coefficient revising module, an ESV evolution analysis module, a driving factor analysis module, and a driving path analysis module; wherein
the data collection module is configured to collect data comprising ESV accounting data and ESV driving data;
the ESV accounting and coefficient revising module is configured to calculate an ecosystem service value by using an equivalent factor method, and revise an equivalent value coefficient through the ESV accounting data;
the ESV evolution analysis module is configured to analyze spatial-temporal evolution characteristics of the ecosystem service value based on the revised equivalent value coefficient and land use data;
the driving factor analysis module is configured to analyze a driving influence of the ESV driving data on the ecosystem service value by using a random forest; and
the driving path analysis module is configured to analyze a driving path of the ESV driving data to the ecosystem service value by using a structural equation model.

The spatial-temporal evolution characteristics comprise spatial-temporal variation, spatial heterogeneity variation, and analysis of cold and hot spots.

The embodiments in the specification are all described in a progressive manner, and each embodiment focuses on differences from other embodiments, and portions that are the same and similar between the embodiments may be referred to each other. Since the device disclosed in the embodiment corresponds to the method disclosed in the embodiment, the description is relatively simple, and reference may be made to the partial description of the method.

The above description of the disclosed embodiments enables those skilled in the art to implement or use the present invention. Various modifications to these embodiments will be readily apparent to those skilled in the art, and the general principles defined herein may be applied to other embodiments without departing from the spirit or scope of the present invention. Thus, the present invention is not intended to be limited to these embodiments shown herein but is to accord with the broadest scope consistent with the principles and novel features disclosed herein.

What is claimed is:

1. A method for analyzing a driving relationship between ecosystem service and urban agglomeration development, comprising:
collecting data comprising ecosystem service value (ESV) accounting data and ESV driving data;
calculating an ESV by using an equivalent factor method, and revising an equivalent value coefficient through the ESV accounting data to obtain a revised equivalent value coefficient;
analyzing spatial-temporal evolution characteristics of the ESV based on the revised equivalent value coefficient and land use data;
analyzing a driving influence of the ESV driving data on the ESV by using a random forest; and
analyzing a driving path of the ESV driving data to the ESV by using a structural equation model.

2. The method for analyzing the driving relationship between ecosystem service and urban agglomeration development according to claim 1, wherein the ESV driving data comprises human activity data and natural condition data.

3. The method for analyzing the driving relationship between ecosystem service and urban agglomeration development according to claim 2, wherein the human activity data comprises population density, night light index, land use structure, and PM_{2.5} concentration, and the natural condition data comprises elevation, grade, normalized difference vegetation index, precipitation, temperature, and drainage density.

4. The method for analyzing the driving relationship between ecosystem service and urban agglomeration development according to claim 1, wherein a calculation process of the ESV is as follows:
ESV=Σⱼ₌₁ⁿΣᵢ₌₁ⁿAᵢ×E_{i,j}×Eⱼ;
wherein ESV is ecosystem services value, E_{i,j} represents a j^{th} ESV coefficient of an i^{th} ecosystem type, Aᵢ is an area of an i^{th} type of ecosystem, and Eⱼ is an ecosystem service equivalent of a j^{th} type of ecosystem after regional correction, Eⱼ=λ·Eₒⱼ; and λ is a region correction coefficient of the ecosystem service equivalent, and Eₒⱼ is a national average ecosystem service equivalent of the j^{th} type of ecosystem.

5. The method for analyzing the driving relationship between ecosystem service and urban agglomeration development according to claim 1, wherein in the random forest, an importance of a variable is estimated by an out-of-bag error sample with the following formula:
$$IMp ( {var}_{i} ) = \frac{{\sum }_{j = 1}^{n} ( errOOB {2}_{i , j} - errOOB {1}_{i , j} )}{n} ;$$
wherein IMp(var₁) is the importance of variable i, errOOB1_{i,j} is an error calculated according to out-of-bag data of the variable i in CARTⱼ, errOOB2_{i,j} is an error calculated according to the out-of-bag data of the variable i in CARTⱼ plus noise interference, and n is a number of CART.

6. The method for analyzing the driving relationship between ecosystem service and urban agglomeration development according to claim 1, wherein the structural equation model is a piecewise structural equation model, the driving path of the ESV driving data is normalized by linear fitting a grouping model, and then an explanation degree of overall fitting of the piecewise structural equation model is evaluated by using Shipley's test of separation.

7. The method for analyzing the driving relationship between ecosystem service and urban agglomeration development according to claim 1, further comprising: quantitatively measuring an interaction relationship among influencing factors of the ESV and a direct or indirect driving effect of the interaction relationship on the ESV through the structural equation model.

8. A system for analyzing the driving relationship between ecosystem service and urban agglomeration development, comprising: a data collection module, an ESV accounting and coefficient revising module, an ESV evolution analysis module, a driving factor analysis module, and a driving path analysis module; wherein
the data collection module is configured to collect data comprising ESV accounting data and ESV driving data;
the ESV accounting and coefficient revising module is configured to calculate an ESV by using an equivalent factor method, and revise an equivalent value coefficient through the ESV accounting data to obtain a revised equivalent value coefficient;
the ESV evolution analysis module is configured to analyze spatial-temporal evolution characteristics of the ESV based on the revised equivalent value coefficient and land use data;
the driving factor analysis module is configured to analyze a driving influence of the ESV driving data on the ESV by using a random forest; and
the driving path analysis module is configured to analyze a driving path of the ESV driving data to the ESV by using a structural equation model.

9. The system for analyzing the driving relationship between ecosystem service and urban agglomeration development according to claim 8, wherein the spatial-temporal evolution characteristics comprise spatial-temporal variation, spatial heterogeneity variation, and analysis of cold and hot spots.
